(19) United States
(12) Patent Application Publication
(10) Pub. No.: US 2021/0324781 A1
(43) Pub. Date: Oct. 21, 2021

(54) FASTENING STRUCTURE

(71) Applicant: ISUZU MOTORS LIMITED, Shinagawa-ku, Tokyo (JP)

(72) Inventor: Hiromichi YAMADA, Fujisawa-shi, Kanagawa (JP)

(21) Appl. No.: 17/273,703

(22) PCT Filed: Sep. 4, 2019
(86) PCT No.: PCT/JP2019/034719

§ 371 Date: Mar. 4, 2021

(30) Foreign Application Priority Data
Sep. 6, 2018 (JP) 2018-166852

(51) Int. Cl. F01N 13/18; F01N 13/10; F16B 5/02

(52) U.S. Cl. CPC F01N 13/1805; F16B 5/02; F01N 13/10

(57) ABSTRACT

This fastening structure 100 on the exhaust side of an internal combustion engine 1 is provided with: a male threaded shaft 10; a pressing body 20 screwed or fixed to the male threaded shaft 10; a through-hole 30 which is formed in a fastening target component 3 and into which the male threaded shaft 10 is inserted; a threaded hole 40 which is formed in a component 2 to be fastened and into which the male threaded shaft 10 is screwed; and a tubular component 50 which is interposed between the pressing body 20 and the fastening target component 3 and into which the male threaded shaft 10 is inserted. The tubular component 50 has a linear expansion coefficient α2 that is greater than the linear expansion coefficient α1 of the fastening target component 3.

### TECHNICAL FIELD

The present disclosure relates to a fastening structure, in particular a fastening structure used on an exhaust side of an internal combustion engine.

### BACKGROUND ART

Generally, in a fastening structure, a bolt is inserted into an insertion hole of a part to be a target of fastening (hereinafter, fastening target part), and the bolt is screwed and tightened to a threaded hole of a part to which the fastening target part is fastened (hereinafter, fastened part).

Further, as a fastening structure, for example, a structure which suppresses loosening of a bolt by a distance piece interposed between a head of the bolt and a fastening target part is known.

### CITATION LIST

### Patent Literature

Patent Literature 1: JP-A-2015-218354

### SUMMARY OF INVENTION

### Technical Problem

By the way, when the fastening structure is used on an exhaust side of an internal combustion engine, the fastening target part (for example, an exhaust manifold), a bolt, and a distance piece are thermally expanded by high temperature exhaust gas. In this case, for example, when the bolt is thermally expanded and extended larger than the exhaust manifold and the distance piece in an axial direction, an axial force of the bolt is reduced, and thus a fastening state may be insufficient.

Therefore, the present disclosure is devised in view of such circumstances, and an object thereof is to provide a fastening structure capable of suppressing a decrease in an axial force of a bolt on an exhaust side of an internal combustion engine.

### Solution to Problem

According to an aspect of the present disclosure, there is provided a fastening structure for fastening a fastening target part to a fastened part on an exhaust side of an internal combustion engine including:

a male threaded shaft;

a pressing body screwed or fixed to the male threaded shaft;

an insertion hole which is formed in the fastening target part and through which the male threaded shaft is inserted;

a threaded hole which is formed in the fastened part and into which the male threaded shaft is screwed; and

a tubular part which is interposed between the pressing body and the fastening target part and through which the male threaded shaft is inserted,

in which the tubular part has a linear expansion coefficient which is larger than a linear expansion coefficient of the fastening target part.

It is preferable that the linear expansion coefficient of the tubular part be larger than a linear expansion coefficient of the male threaded shaft.

It is preferable that the fastening target part be an exhaust manifold, and the fastened part be a cylinder head.

It is preferable that the linear expansion coefficient of the male threaded shaft be larger than the linear expansion coefficient of the fastening target part.

### Advantageous Effects of Invention

According to the present disclosure, it is possible to suppress a decrease in the axial force of the bolt on the exhaust side of the internal combustion engine.

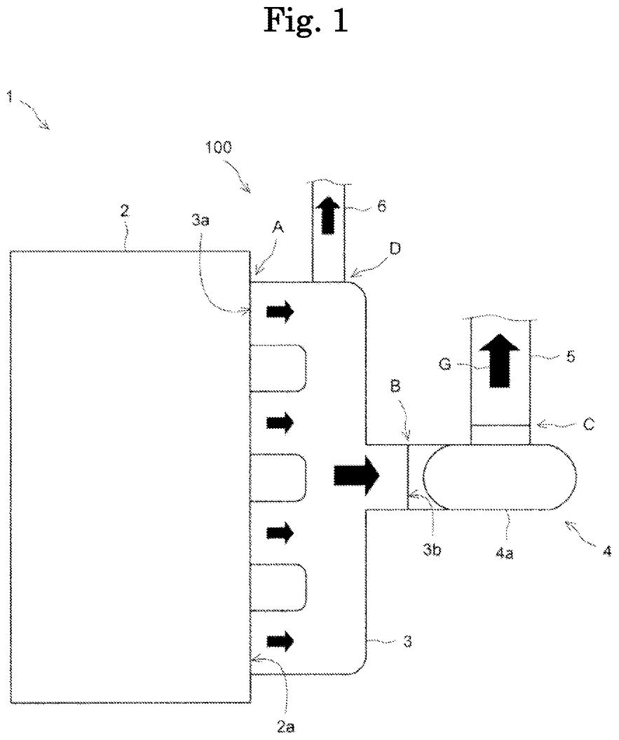

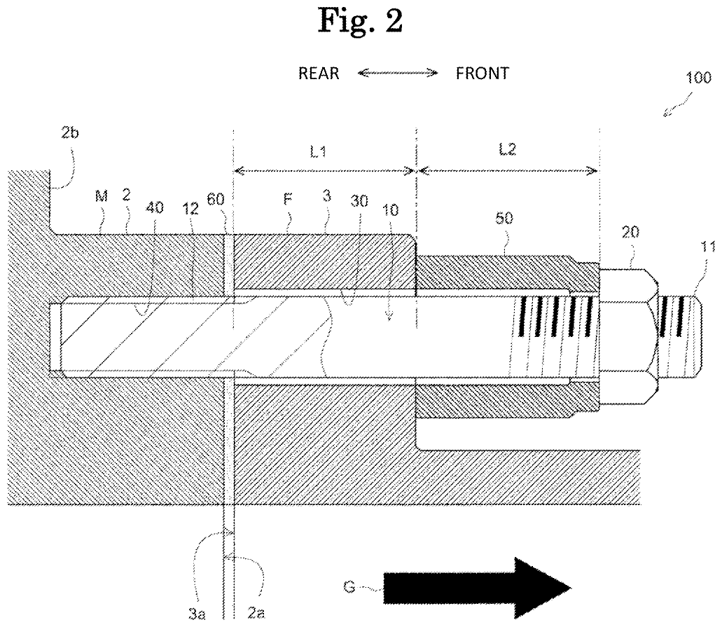

### BRIEF DESCRIPTION OF DRAWINGS

[FIG. 1] FIG. 1 is an overall configuration diagram of an exhaust side of an internal combustion engine.

[FIG. 2] FIG. 2 is a partial cross-sectional view of a fastening structure in a part A of FIG. 1.

### DESCRIPTION OF EMBODIMENT

Hereinafter, an embodiment of the present disclosure will be described with reference to the accompanying drawings. It should be noted that the present disclosure is not limited to the following embodiment.

FIG. 1 is an overall configuration diagram of an exhaust side of an internal combustion engine 1. An arrow G indicates a flow of exhaust gas.

As illustrated in FIG. 1, the internal combustion engine 1 is a multi-cylinder compression ignition type internal combustion engine mounted on a vehicle (not illustrated), that is, a diesel engine. The vehicle is a large vehicle such as a truck. However, there are no particular restrictions on a type, form, application, and the like of the vehicle and the internal combustion engine 1. For example, the vehicle may be a small vehicle such as a passenger car, and the internal combustion engine 1 may be a spark-ignition type internal combustion engine, that is, a gasoline engine.

The internal combustion engine 1 includes a cylinder head 2 connected to an upper part of a cylinder block (not illustrated), and an exhaust manifold 3 connected to an exhaust side of the cylinder head 2. The internal combustion engine 1 also includes intake system parts such as an intake manifold (not illustrated), but description thereof will be omitted here.

The cylinder head 2 forms a plurality of combustion chambers (not illustrated) with the cylinder block. Further, the cylinder head 2 has a plurality (four in the illustrated example) of exhaust outlets 2a for each cylinder.

Exhaust inlets 3a for each cylinder of the exhaust manifold 3 are connected to the exhaust outlets 2a of the cylinder head 2. Further, an exhaust pipe 5 is connected to an exhaust outlet 3b which is a collective outlet of the exhaust manifold 3, via a turbine casing 4a of a turbocharger 4. A reference numeral 6 indicates an EGR pipe 6, connected to the exhaust manifold 3, for returning a part of the exhaust gas to an intake side.

A fastening structure 100 according to the embodiment is used to fasten the exhaust manifold 3 as a fastening target part to the cylinder head 2 as a fastened part.

FIG. 2 is a partial cross-sectional view of the fastening structure 100 in a part A of FIG. 1. A front-rear direction illustrated in FIG. 2 coincides with an axial direction of a bolt 10, but it is only defined for convenience of explanation.

As illustrated in FIG. 2, the fastening structure 100 includes the bolt 10 as a male threaded shaft and a nut 20 as a pressing body screwed to the bolt 10. Further, the fastening structure 100 includes an insertion hole 30 into which the bolt 10 is inserted, which is formed in the exhaust manifold 3, and a threaded hole 40 to which the bolt 10 is screwed, which is formed in the cylinder head 2 . Further, the fastening structure 100 includes a distance piece 50 as a tubular part through which the bolt 10 is inserted, which is interposed between the nut 20 and the exhaust manifold 3. Reference numeral 60 indicates a gasket interposed between the cylinder head 2 and the exhaust manifold 3.

The bolt 10 is a stud bolt having male threads at a front end portion 11 and a rear end portion 12. In the embodiment, the nut 20 is screwed to the front end portion 11 of the bolt 10, and the threaded hole 40 is screwed to the rear end portion 12. However, any type of the bolt 10 may be used, and for example, a bolt with a hexagonal head may be used. In this case, the bolt 10 is integrally fixed to and provided with a head as a pressing body instead of the nut 20.

A flange F is formed in the exhaust inlets 3a of the exhaust manifold 3. A plurality (for example, four) of insertion holes 30 are formed in the flange F.

A mounting portion M for mounting the flange F of the exhaust manifold 3 is formed in the exhaust outlets 2a of the cylinder head 2. The mounting portion M is formed by projecting from a side wall 2b of the cylinder head 2. A plurality (for example, four) of threaded holes 40 are formed in the mounting portion M coaxially with the insertion holes 30. Although not illustrated, the mounting portion M may be a flange.

The distance piece 50 is formed into a cylindrical shape. Further, the distance piece 50 has a same length L2, in the front-rear direction, as a length L1 of the insertion hole 30 of the exhaust manifold 3 (L1=L2). However, any shape and length of the distance piece 50 may be used. For example, the length L2 of the distance piece 50 may be longer than the length L1 of the insertion hole 30 (L1<L2), or may be shorter (L1>L2).

Although not illustrated, the distance piece 50 has a linear expansion coefficient α2 which is larger than a linear expansion coefficient α1 of the exhaust manifold 3 (α1<α2). Specifically, cast iron (FCD) or the like is used as a material of the exhaust manifold 3, and austenitic stainless steel (SUS304) or the like is used as a material of the distance piece 50.

Further, in the embodiment, the linear expansion coefficient α2 of the distance piece 50 is larger than a linear expansion coefficient α3 of the bolt 10 (α3<α2). Further, the linear expansion coefficient α3 of the bolt 10 is larger than the linear expansion coefficient α1 of the exhaust manifold 3 (α1<α3). Specifically, austenitic heat-resistant steel (SUH660) or the like is used as a material of the bolt 10.

As described above, in the embodiment, the linear expansion coefficient α1 of the exhaust manifold 3, the linear expansion coefficient α2 of the distance piece 50, and the linear expansion coefficient α3 of the bolt 10 have a relation of α1<α3<α2.

Next, an operation effect of the fastening structure 100 according to the embodiment will be described.

As illustrated in FIG. 2, in the fastening structure 100, after screwing and fixing the rear end portion 12 of the bolt 10 to the threaded hole 40 of the cylinder head 2, the insertion hole 30 of the exhaust manifold 3 and the distance piece 50 are inserted in this order into the bolt 10 projecting forward from the threaded hole 40. Then, by screwing and tightening the nut 20 to the front end portion 11 of the bolt 10, the exhaust manifold 3 is pressed against the cylinder head 2 by the nut 20 via the distance piece 50, and the exhaust manifold 3 is fastened to the cylinder head 2. When the nut 20 is loosened and removed from the bolt 10, the fastening can be released.

Further, by tightening the nut 20 to the bolt 10, the distance piece 50 can be compressed in the axial direction, and thus the axial force of the bolt 10 can be increased by a repulsive force thereof As a result, loosening of the bolt 10 can be suppressed.

By the way, the fastening structure 100 according to the embodiment is used for fastening the cylinder head 2 of a high temperature portion on an upstream side of the exhaust and the exhaust manifold 3 of a low temperature portion on a downstream side of the exhaust. Therefore, the exhaust manifold 3, the bolt 10, and the distance piece 50 are thermally expanded by high-temperature exhaust gas discharged from a combustion chamber of the internal combustion engine 1 and the heat received from the cylinder head 2.

Further, the bolt 10 of the embodiment has the linear expansion coefficient α3 which is larger than the linear expansion coefficient α1 of the exhaust manifold 3 (α1<α3), and thus the bolt 10 is thermally expanded and extended larger than the exhaust manifold 3 in the axial direction.

Therefore, when the linear expansion coefficient α2 of the distance piece 50 is equal to or less than the linear expansion coefficient α1 of the exhaust manifold 3 (α2≤α1<α3), the bolt 10 is thermally expanded and extended larger than the exhaust manifold 3 and the distance piece 50 in the axial direction. As a result, the axial force of the bolt 10 may decrease, resulting in insufficient fastening of the cylinder block 2 and the exhaust manifold 3. Then, there is a risk that exhaust sealing performance may deteriorate between fastening surfaces of the two.

However, in the embodiment, the distance piece 50 has the linear expansion coefficient α2 which is larger than the linear expansion coefficient α1 of the exhaust manifold 3 (α1<α2). Therefore, the distance piece 50 is thermally expanded and extended larger than the exhaust manifold 3 in the axial direction, and a difference in the thermal expansion (linear expansion coefficient) between the bolt 10 and the exhaust manifold 3 can be filled. As a result, it becomes possible to suppress a decrease in the axial force of the bolt 10.

Further, the distance piece 50 of the embodiment has the linear expansion coefficient α2 which is larger than the linear expansion coefficient α3 of the bolt 10 (α3<α2). Therefore, it is possible to thermally expand the distance piece 50 larger than the bolt 10 and more reliably suppress the decrease in the axial force of the bolt 10.

Further, the basic embodiment described above can be a modification example or a combination thereof as follows. In the following description, the same reference numerals are used for the same components as those in the embodiment described above and detailed description thereof will be omitted.

### First Modification Example

The fastening structure 100 can be used for connecting any parts to each other on the exhaust side of the internal combustion engine 1. For example, in a B part of FIG. 1, the exhaust manifold 3 is a fastened part, and the turbine casing 4a of the turbocharger 4 is a fastening target part. Further, in a C part of FIG. 1, the turbine casing 4a is a fastened part, and the exhaust pipe 5 is a fastening target part. Further, in a D part of FIG. 1, the exhaust manifold 3 is a fastened part, and the EGR pipe 6 is a fastening target part. Further, although not illustrated, the fastening structure 100 can also be used for connecting a catalyst casing accommodating a catalyst, such as an oxidation catalyst or the like, and an exhaust pipe.

### Second Modification Example

The fastened part and the fastening target part described above may have opposite relations with each other. For example, the turbine casing 4a may be a fastening target part and the exhaust pipe 5 may be a fastened part.

### Third Modification Example

The linear expansion coefficient α2 of the distance piece 50 may be equal to or less than the linear expansion coefficient α3 of the bolt 10 (α2≤α3). Further, the linear expansion coefficient α3 of the bolt 10 may be equal to or less than the linear expansion coefficient α1 of the exhaust manifold 3 (α3≤α1).

Although the embodiment of the present disclosure is described in detail above, the embodiment of the present disclosure is not limited to the embodiment described above. Also, all modification examples, application examples, and equivalents contained in the ideas of the present disclosure as defined by the claims are included in the present disclosure. Therefore, the present disclosure should not be construed in a limited way and can be applied to any other technique that belongs within the scope of the ideas of the present disclosure.

This application is based on a Japanese patent application (Japanese Patent Application No. 2018-166852) filed on Sep. 6, 2018, the contents of which are incorporated herein by reference.

### INDUSTRIAL APPLICABILITY

According to the present disclosure, it is useful in that it is possible to provide a fastening structure capable of suppressing a decrease in an axial force of a bolt on an exhaust side of an internal combustion engine.

### REFERENCE SIGNS LIST

1 Internal combustion engine

2 Cylinder head (fastened part)

3 Exhaust manifold (fastening target part)

10 Bolt (male threaded shaft)

20 Nut (pressing body)

30 Insertion hole

40 Threaded hole

50 Distance piece (tubular part)

60 Gasket

100 Fastening structure

G Exhaust gas

1. A fastening structure for fastening a fastening target part to a fastened part on an exhaust side of an internal combustion engine, comprising:
a male threaded shaft;
a pressing body screwed or fixed to the male threaded shaft;
an insertion hole which is formed in the fastening target part and through which the male threaded shaft is inserted;
a threaded hole which is formed in the fastened part and into which the male threaded shaft is screwed; and
a tubular part which is interposed between the pressing body and the fastening target part and through which the male threaded shaft is inserted,
wherein the tubular part has a linear expansion coefficient which is larger than a linear expansion coefficient of the fastening target part.

2. The fastening structure according to claim 1,
wherein the linear expansion coefficient of the tubular part is larger than a linear expansion coefficient of the male threaded shaft.

3. The fastening structure according to claim 1,
wherein the fastening target part is an exhaust manifold, and
the fastened part is a cylinder head.

4. The fastening structure according to claim 1,
wherein a linear expansion coefficient of the male threaded shaft is larger than the linear expansion coefficient of the fastening target part.
